(19) United States
(12) Patent Application Publication
(10) Pub. No.: US 2008/0172148 A1
(43) Pub. Date: Jul. 17, 2008

(54) Method and Device For Making Secure Low Altitude Automatic Flight of an Aircraft

(75) Inventors: Eric Isorce, Blagnac (FR); Franck Artini, Toulouse (FR)

Correspondence Address: STEVENS DAVIS LLP, 1615 L STREET NW, SUITE 850, WASHINGTON, DC, 20036, US

(73) Assignee: AIRBUS, Blagnac (FR)

(21) Appl. No.: 11/994,989

(22) PCT Filed: Jul. 20, 2006
(86) PCT No.: PCT/FR2006/001776

§ 371 Date: Jan. 7, 2008

(30) Foreign Application Priority Data
Jul. 21, 2005 (FR) 05 07739

(51) Int. Cl. G05D 1/04; G06F 17/11

(52) U.S. Cl. 701/9

(57) ABSTRACT

The invention concerns a device (1) comprising first means (3) for determining a threshold value depending at least on one low altitude flight path, which is followed by an aircraft, as well as on navigation errors, for guiding and calculating the flight path, second means (4) for measuring the current real height of the aircraft above the overflown ground during a low altitude flight along the flight path, third means (5) for comparing said current real height to the threshold value, and fourth means (8) for emitting a warning signal, if the current real height drops to or below the threshold value, as well as optionally fifth means (10) for controlling the aircraft so as to increase its altitude and bring it to a secure altitude, when the current real height drops below or to the threshold value.

The present invention relates to a method and device for making secure a low-altitude automatic flight of an aircraft, which is (automatically) guided along a low-altitude flight trajectory comprising a lateral trajectory and a vertical trajectory.

Although not exclusively, the present invention applies more particularly to a military transport airplane which exhibits a low thrust/weight ratio and a high inertia, and whose maneuvering times are in general relatively slow.

Within the framework of the present invention, the expression low-altitude flight means flight along a flight trajectory (at low altitude) allowing an aircraft to follow as closely as possible the terrain overflown, in particular so as to avoid being pinpointed. A low-altitude flight trajectory such as this is therefore most usually situated at the lowest at a predetermined height from the terrain, for example 500 feet (about 150 meters).

Because of this proximity to the ground, any downward vertical deviation (beyond a certain security margin) of the aircraft, with respect to the flight trajectory to be followed, during the guidance of the aircraft along said flight trajectory, presents a significant risk of collision with the terrain overflown (directly with the ground or with a structure or an element situated on said ground). Of course, the existence of such a risk is not acceptable (or only with a probability of occurrence per flying hour that is less than a predetermined security objective).

The present invention is aimed at making secure a low-altitude flight of an aircraft (which is automatically guided along a flight trajectory comprising a lateral trajectory and a vertical trajectory) so as to render any collision of the aircraft with the terrain overflown highly improbable.

The presents invention applies more particularly to an automatic flight which is autonomous, that is to say an automatic flight which is performed solely by virtue of navigation, flight management and guidance systems and of a digital terrain database, which are carried on board, without the aid of any forward emissive device, such as a radar for example. It is known that an autonomous automatic flight such as this may be subject to a whole set of errors relating in particular to:
navigation: the position given by the onboard navigation system is not exactly the real position of the aircraft;
guidance: an automatic pilot slaves the position given by the navigation system to a trajectory calculated by a flight management system. This slaving exhibits an intrinsic performance which conveys the ability of the automatic pilot to guide the aircraft over the requested trajectory. A guidance error may also exist during a flight with the aid of a flight director that the pilot must follow manually;
flight trajectory: the accuracy of this trajectory depends on the accuracy of the algorithm and processor of the computer used, and also especially possible errors of digital modeling of the terrain overflown (that is to say errors relating to the digital terrain database used).

It will be noted that monitoring the deviation between the estimated position of the aircraft and the calculated low-altitude flight trajectory that the aircraft must follow, so as possibly to detect an excessive vertical deviation, does not make it possible to take account in particular of the influence of the navigation errors and errors relating to the digital terrain database used.

The present invention is aimed at remedying these drawbacks. It relates to a particularly effective method for making secure a low-altitude automatic and autonomous flight of an aircraft, which is therefore guided (automatically and in an autonomous manner) along a low-altitude flight trajectory.

For this purpose, according to the invention, said method is noteworthy in that:

A/ during said low-altitude flight, the following string of successive operations is carried out in an automatic and repetitive manner:

a) a current threshold value is determined, depending at least on the current altitude of said low-altitude flight trajectory, which is followed by the aircraft, as well as on navigation errors of the aircraft, guidance errors of the aircraft and errors in calculating said flight trajectory;

b) a current real height of the aircraft above the terrain overflown is measured; and

c) this measured current real height is compared with said current threshold value; and

B/ if said current real height becomes less than or equal to said current threshold value, an alert signal is emitted (audible and/or visual).

Thus, by virtue of the invention, it is possible to detect any excessive downward vertical deviation, by monitoring the current real height of the aircraft (that is to say by measuring it in a repetitive manner and by comparing it with said predetermined threshold value). Such verification is particularly effective, since it takes account, not of an estimated height, but of the current real height of the aircraft, that is to say of the actual height with respect to the real terrain.

Moreover, as specified below, said threshold value is determined so as to take into account the various errors liable to appear during a low-altitude automatic and autonomous flight such as this.

In a preferred embodiment, in step A/a), said threshold value H0 is calculated with the aid of the following expression (1):

$$H 0 = Z 1 - Zmoy - ( {\sum }_{i} Li )$$

in which:
Z1 represents the current altitude of said flight trajectory (calculated), which corresponds to the current lateral position of the aircraft, that is to say the altitude which corresponds to the orthogonal projection of the current lateral position of the aircraft onto the calculated flight trajectory;
Zmoy represents an average altitude of the digital terrain under the aircraft, which arises from a digital terrain database; and
the values Li represent the limits at least of the navigation and guidance errors and of errors relating to said digital terrain database, which is used to calculate said low-altitude flight trajectory. Each limit expresses the fact that the corresponding error is not greater than this limit with a larger probability than an objective probability. In this case, the objective probability is that for which the alert signal should not be emitted during the low-altitude flight.

Furthermore, when the terrain overflown by the aircraft is substantially flat:
Z1 represents a predetermined guard height HG, for example 500 feet (about 150 meters); and
Zmoy is considered to be zero, so as to obtain a simplified expression for calculating the threshold value H0, namely

$$H 0 = HG - ( {\sum }_{i} Li )$$

Furthermore, advantageously, in step A/b) said real height is measured with the aid of a radioaltimeter.

Additionally, in step B/, if said current real height becomes less than or equal to said current threshold value, in addition to emitting an alert signal, the low-altitude flight is interrupted and the aircraft is controlled (automatically and manually) so as to increase its altitude such as to bring it to a security altitude (before possibly returning to a low-altitude flight if this proves to be possible).

The present invention also relates to a device for making secure a low-altitude flight of an aircraft which is automatically guided (and in an autonomous manner) along a (low-altitude) flight trajectory.

According to the invention, this device is noteworthy in that it comprises:
first means for determining a current threshold value depending at least on the current altitude of said low-altitude flight trajectory (precalculated), which is followed by the aircraft, as well as navigation errors, guidance errors and errors in calculating the flight trajectory. The latter depend mainly on an error relating to the digital terrain database used, whether it arises from a file loaded from the ground or formulated aboard the aircraft for example with the aid of a radar in ground mapping mode;
second means, in particular at least one radioaltimeter, for measuring a current real height of the aircraft above the terrain overflown, during a low-altitude flight along said flight trajectory;
third means which are linked to said first and second means, for comparing said current real height with said current threshold value; and
fourth means which are linked to said third means, for emitting an alert signal if said current real height becomes less than or equal to said current threshold value.

Furthermore, in a particular embodiment, the device in accordance with the invention comprises, moreover, fifth means for controlling the aircraft so as to increase its altitude and bring it to a security altitude, when said current real height becomes less than or equal to said current threshold value.

The figures of the appended drawing will elucidate the manner in which the invention may be embodied. In these figures, identical references designate similar elements.

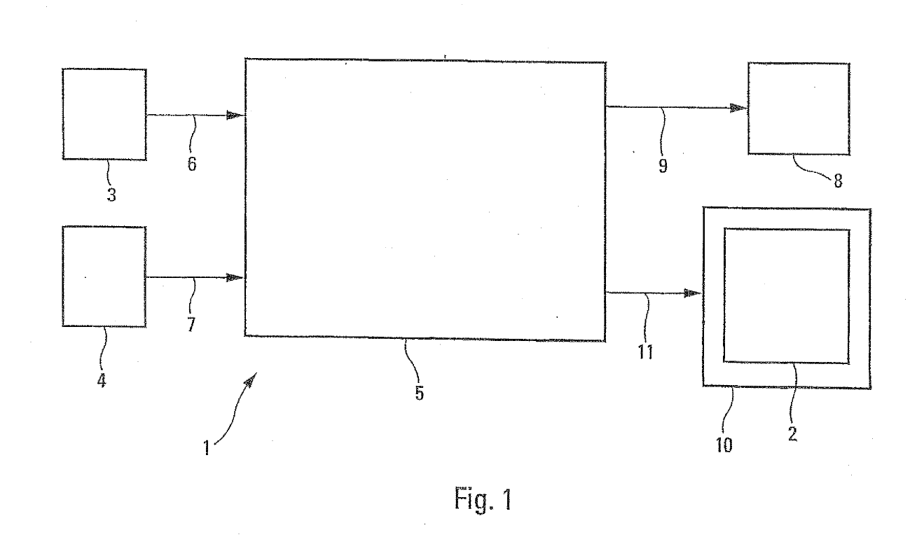

FIG. 1 is the schematic diagram of a device in accordance with the invention.

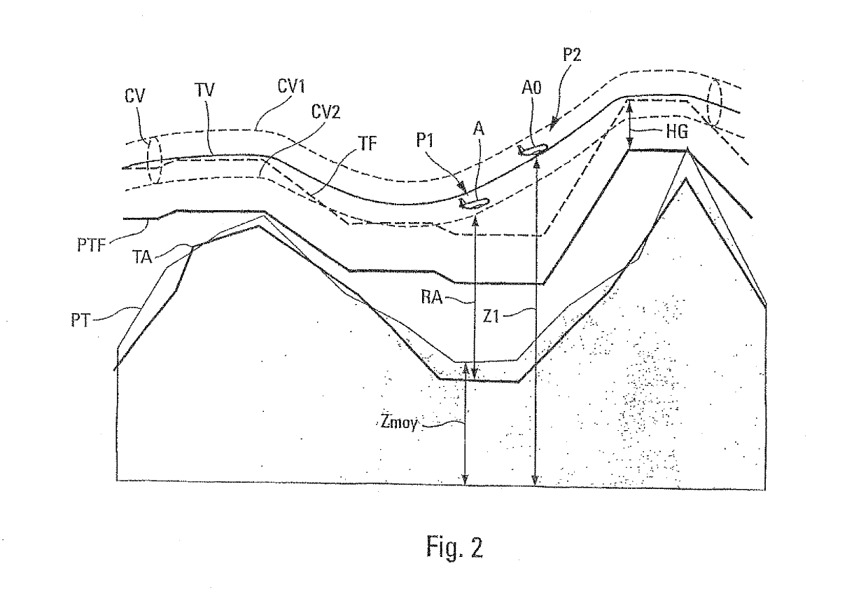

FIG. 2 schematically illustrates in a vertical plane the main characteristics taken into account for the implementation of the present invention.

The device 1 in accordance with the invention and schematically represented in FIG. 1, is intended to make secure a low-altitude flight of an aircraft A, for example of a transport airplane, a fighter or a helicopter.

Said device 1 is associated with a standard piloting system 2, which is carried on board the aircraft A and which comprises:
means, for example a flight management system, for determining a flight trajectory T0 comprising a trajectory TL defined in a horizontal plane and a vertical trajectory TV (or flight profile) defined in a vertical plane. To be able to carry out a low-altitude flight, the (low-altitude) flight trajectory T0 must allow the aircraft A to follow as closely as possible the terrain TA overflown (at a minimum height from the ground corresponding to a guard height selected by the pilot); and
a guidance means, for example an automatic pilot, for guiding the aircraft A along said flight trajectory T0. This guidance means determines orders for piloting the aircraft A which are such that the latter follows said flight trajectory T0. These piloting orders are transmitted to means for actuating controlled members, such as for example control surfaces (rudder, elevators, etc.) of the aircraft A.

According to the invention, said device 1, which is therefore intended to make secure the low-altitude flight of the aircraft A which is automatically guided along a low-altitude flight trajectory T0, comprises:
means 3 for determining a current threshold value H0, depending at least on the current altitude Z1 (that is to say the altitude at an estimated current position P2 of the aircraft A and specified below) of said low-altitude flight trajectory T0, which is followed by the aircraft A, as well as navigation errors of the aircraft A, guidance errors of the aircraft A and errors in calculating said flight trajectory T0;
means 4 for measuring (in a repetitive manner) the current real height RA of the aircraft A above the real terrain TA overflown;
means 5 which are connected by way of links 6 and 7 respectively to said means 3 and 4 and which are intended to compare (in a repetitive manner) said current real height RA with said current threshold value H0; and
means 8 which are connected by way of a link 9 to said means 5 and which are intended to emit an alert signal, as soon as said measured current real height RA of the aircraft A becomes less than or equal to said calculated current threshold value H0.

In a particular embodiment:
said means 4 comprise at least one radioaltimeter, that is to say a radio navigation apparatus which is installed aboard the aircraft A and which uses the reflection of radioelectric waves on the ground (real terrain TA) with a view to determining the real height RA of the aircraft A above said ground (real terrain TA); and
said means 8 are formed so as to be able to emit an alert signal of visual type and/or of audible type.

The device 1 in accordance with the invention also comprises means 10 which are connected by way of a link 11 to said means 5 and which are formed so as to control the aircraft A in such a way as to increase its altitude and bring it to a predetermined security altitude, when the current real height RA of the aircraft A becomes less than or equal to said current threshold value H0.

In a preferred embodiment, said means 10 are automatic piloting means and comprise for example the aforesaid automatic piloting system 2. However, these means 10 can also comprise standard manual piloting means.

The present invention applies more particularly to an automatic flight which is autonomous, that is to say an automatic flight which is performed solely by virtue of navigation, flight management and guidance systems and of a digital terrain database, which are carried on board, without the aid of any forward emissive device, such as a radar for example.

The device 1 in accordance with the invention is able to detect any excessive downward vertical deviation, by monitoring the current height RA of the aircraft A (that is to say by measuring it in a repetitive manner and by comparing it with said threshold value H0 calculated in a repetitive manner). Such verification is particularly effective, since it takes account of the real current height RA of the aircraft A and not of an estimated height. This height RA is real, since it is measured with respect to the real terrain TA and not calculated with respect to an estimated terrain, as specified below with reference to FIG. 2.

Moreover, as also specified hereinafter, said threshold value H0 is determined so as to take into account the various errors liable to appear during a low-altitude automatic and autonomous flight. Moreover, it is calculated with respect to a precalculated reference so that the method in accordance with the invention is called a method “based on radioaltimeter height correlation” (namely correlation between the height RA and the flight setpoint represented by the precalculated flight trajectory T0).

It is known that an automatic and autonomous flight such as this may be subject to a whole set of instantaneous errors, both in the vertical plane and in the lateral plane, and in particular to:
a navigation error PEE: the position given by an onboard navigation system is not exactly the real position at the aircraft A;
a guidance error FTE: the guidance means of the automatic piloting system 2 slaves the position given by the navigation system to the flight trajectory T0 calculated by the flight management system. This slaving exhibits an intrinsic performance which conveys the ability of the guidance means (automatic pilot for example) to guide the aircraft over the requested flight trajectory T0. A guidance error can also exist during a flight with the aid of a flight director that the pilot must follow manually; and a flight trajectory error PDE: the accuracy of the flight trajectory depends on the accuracy of the algorithm and the processor of the computer used, and also and especially on a possible digital modeling error of the terrain overflown (that is to say an error DTDBE relating to the digital terrain database, used to calculate the flight trajectory T0).

It will be noted that the sum of the various errors defines a Total System Error TSE.

In a preferred embodiment, said means 3 calculate said current threshold value H0 with the aid of the following expression (1):

$$H 0 = Z 1 - Zmoy - ( {\sum }_{i} Li )$$

in which:
Z1 represents the current altitude along said flight trajectory T0 which is followed by said aircraft A, that is to say the altitude at the position P2 specified below, namely the altitude of the flight trajectory T0 corresponding to the estimated current lateral position of the aircraft A;
Zmoy represents an average altitude of the digital terrain under the aircraft A at the real position P1 specified below. This digital terrain PT arises from a digital terrain database, as specified below; and
the values Li represent the limits at least:
   of vertical navigation errors PEEz;
   of vertical guidance errors FTEz; and
   of vertical errors DTDBEz relating to the digital terrain database, which is used to calculate said low-altitude flight trajectory T0.

FIG. 2 is returned to in order to properly elucidate the characteristics of the present invention, in which figure are shown, in a vertical plane:
the so-called real aircraft A, that is to say which is shown at the real position P1 thereof;
the vertical trajectory TV of the flight trajectory T0 as calculated;
the aircraft AO termed estimated, that is to say which is shown at the estimated position P2 thereof on said flight trajectory T0 as calculated. The positions P1 and P2 correspond to one and the same instant;
a flight tunnel CV defined around the flight trajectory T0 (in this instance the vertical trajectory TV) and exhibiting an upper limit CV1 and a lower limit CV2;
the profile of the terrain PT such as arises from the digital terrain database used;
a filtered terrain profile PTF calculated on the basis of said terrain profile PT, as specified below;
a filtered terrain TF which is obtained with the aid of an upward translation of a guard height HG, for example 500 feet (about 150 meters), on the basis of said filter terrain profile PTF; and
the real terrain TA, that is to say the physical terrain.

Operationally, a lateral trajectory TL is defined firstly by the operator (directly or via an auto-router system). Along this lateral trajectory TL, the vertical trajectory TV of the low-altitude flight is calculated above the filtered terrain TF which is obtained or the basis of the filtered terrain profile PTF. The latter is determined on the basis of the terrain profile PT arising from the digital terrain database in the following manner: for each abscissa along the lateral trajectory TL, the corresponding terrain elevation is the highest elevation of PT (that is to say extracted from the digital terrain database) under an extraction surface which corresponds globally laterally to the width of a flight corridor plus, on each side of the trajectory, the limit of the error PDE corresponding to a probability objective. Longitudinally, the extraction surface thus takes into account the longitudinal errors.

Consequently, within the framework of the present invention, an alert signal is emitted when the vertical deviation between, on the one hand, the current real position P1 (of the real aircraft A) and, on the other hand, the corresponding position P2 of the calculated trajectory TV, is larger than an alarm threshold, that is to say when:

height RA≦defined altitude−average altitude of the digital terrain under the real aircraft A−(sum of the limits of the errors FTEz, PEEz, DTDBEz)

where:
the defined altitude is the altitude Z1 of the position P2;
the errors FTEz, PEEz and DTDBEz are the vertical components of the aforesaid errors FTE, PEE and DTDBE;
the limits of the errors FTEz, PEEz and DTDBEz are the limits of these errors, given for a probability which corresponds to a maximum operationally admissible excursion probability for the tunnel CV (10⁻³, 10⁻⁴/hdv, etc.), hdv signifying flying hour;
the average altitude of the digital terrain under the aircraft A is the average altitude in the circle of the limit of the chosen error PEE (corresponding to the chosen maximum probability), which is centered on the estimated lateral position of the aircraft A, and given for the same excursion probability as the vertical errors hereinabove.

Above a flat terrain, the alert signal is emitted when:

height RA≦guard height HG−(sum of the limits of the errors FTEz, PEEz, DTDBEz).

Specifically, when the terrain TA overflown by the aircraft A is substantially flat, it is envisaged according to the invention that:
Z1 represents the guard height HG in said expression (1); and
Zmoy is considered to be zero,

so as to obtain a simplified expression for calculating the threshold value H0, namely

$$H 0 = HG - ( {\sum }_{i} Li )$$

Hereinafter, a system failure which happens with a probability Pj and which induces an upward or downward deviation dj with the same probability is considered.

The aircraft A hits the ground (real terrain TA) if the downward deviation with or without system failure is larger than the guard height HG, in general 500 feet (about 150 meters), and no alert signal is emitted by the means 8.

Moreover, this assumes that the crew of the aircraft A are capable of countering the deviation due to this failure, right from the moment an alert signal is emitted and therefore that the loss of height during this maneuver is less than 500 feet minus the alarm threshold:

$$P = \frac{1}{2} P ( \vert TSEz \pm dj \vert > d ) \cdot P ( alert signal not emitted )$$

with:

P(|TSEz±dj|>d)=Pj[1−P(0≦TSEz≦d−dj)−P(0≦TSEz≦d+dj)]+(1−Pj)[1−2.P(0≦TSEz≦d)]

It will be noted that d represents the value of the guard height HG, chosen in general by the pilot of the aircraft A.

The previous probability must be less than the chosen security objective, for example 10⁻⁹/hdv. It may be seen that with P(alert signal not emitted)<1, the probability that TSEz≧500 feet (or that TSEz≧(500−dj)) can be larger than 10⁻⁹/hdv, since it is necessary to combine it with the probability of not detecting an exit from the tunnel CV.

The threshold of the alarm (threshold value H0) therefore also depends on the recovery capacity of the aircraft A in the presence of a system failure.

By way of example, if:
PDEz≈30 meters at 90%;
PEEz≈70 meters at 99.99999%;
PSEz≈60 feet at 95%,

then, assuming that these errors are Gaussian:
the total standard deviation σ of TSEz=80 feet (about 24 meters), therefore TSEz=1.960×80≈150 feet (about 45 meters) at 95%;
P(alert signal not emitted): must be consistent with the operational availability objective regarding the aircraft A.

If a system failure happening with a probability (for example) Pj=10⁻⁵/hdv and dj=300 feet (about 90 meters) is considered, then the probability that the aircraft A hits the ground TA is about 6.2.10⁻⁸/hdv without alert signal.

But if the alert signal is envisaged, she probability that this alert signal is not emitted must be ≦1.6.10⁻²/hdv only, so that the probability of hitting the ground is ≦10⁻⁹/hdv [provided that the loss of height during the recovery maneuver triggered as soon as the alert signal is emitted is less than 200 feet (about 60 meters) (200=500−300)].

This objective of 1.6.10⁻²/hdv is amply within the range of current systems.

Consequently, for the implementation of the present invention, it therefore suffices, after having on the ground:
estimated the elementary errors (navigation, guidance, digital terrain database, etc.), thereby making it possible in the case of Gaussian errors to determine the standard deviation or each error, and thereafter that of the total error (apart from system failure);
defined at least one system failure to be taken into account in the security study, as well as its probability of occurrence and the vertical deviation that it induces;
evaluated the loss of height, during the recovery maneuver in the presence of this system failure; and
specified the security level required in the form of a probability of collision with the ground not to be exceeded, that is to say of a probability that the total deviation is greater than or equal to the selectable minimum guard height (500 feet typically), to:
define the threshold value H0 according to operational objectives (maximum probability of interrupting the mission because of the alert signal and trajectory tracking performance) as well as in security terms (probability of hitting the ground); and
to contrive matters so as to comply with the probability objective for non-detection of an overshoot of this threshold value, so as to comply with the overall security objective.

It will be noted that the crew of the aircraft A must be aware that the device 1 in accordance with the invention can emit an alert signal, while the real height RA of the aircraft A is much greater than the guard height HG. This case can appear typically when the flight trajectory T0 sinks into the trough of a valley, but the aircraft A diverges sufficiently therefrom, in order for the alert signal to be emitted.

In general, it will be verified that this flight trajectory T0 is:
flyable in relation to the climb performance of the aircraft A;
maneuverable in relation to the maximum admissible load factors, and
still situated at a guard height above the filtered terrain PTF.

1-10. (canceled)

11. A method for making secure a low-altitude flight of an aircraft (A) which is automatically guided along a low-altitude flight trajectory, wherein:
A/ during said low-altitude flight, the following string of successive operations is carried out in an automatic and repetitive manner:
a) a current threshold value is determined, depending at least on the current altitude (Z1) of said low-altitude flight trajectory, which is followed by the aircraft (A), as well as on navigation errors of the aircraft (A), guidance errors of the aircraft (A) and errors in calculating said flight trajectory;
b) a current real height (RA) of the aircraft (A) above the terrain (TA) overflown is measured; and
c) this measured current real height (RA) is compared with said current threshold value; and
B/ if said current real height (RA) becomes less than or equal to said current threshold value, an alert signal is emitted.

12. The method as claimed in claim 11, wherein in step A/a), said threshold value H0 is calculated with the aid of the following expression:
$$H 0 = Z 1 - Zmoy - ( {\sum }_{i} Li )$$
in which:
Z1 represents the current altitude of said flight trajectory, which is followed by the aircraft (A);
Zmoy represents an average altitude of the terrain under the aircraft (A), which arises from a digital terrain database; and
the values Li represent the limits at least of said navigation and guidance errors and of errors relating to said digital terrain database, which is used to calculate said low-altitude flight trajectory.

13. The method as claimed in claim 12, wherein, when the terrain overflown (TA) by the aircraft (A) is substantially flat:
Z1 represents a predetermined guard height; and
Zmoy is considered to be zero.

14. The method as claimed in claim 11, wherein in step A/b), said real height (RA) is measured with the aid of a radioaltimeter.

15. The method as claimed in claim 11, wherein in step B/, if said current real height (RA) becomes less than or equal to said current threshold value, the low-altitude flight is interrupted and the aircraft (A) is controlled so as to increase its altitude such as to bring it to a security altitude.

16. A device for making secure a low-altitude flight of an aircraft (A) which is automatically guided along a low-altitude flight trajectory, wherein it comprises:
first means (3) for determining a current threshold value depending at least on the current altitude (Z1) of said low-altitude flight trajectory, which is followed by the aircraft (A), as well as navigation errors, guidance errors and errors in calculating said flight trajectory;
second means (4) for measuring a current real height (RA) of the aircraft (A) above the terrain (TA) overflown during a low-altitude flight along said flight trajectory;
third means (5) which are linked to said first and second means (3, 4), for comparing said current real height (RA) with said current threshold value; and
fourth means (8) which are linked to said third means (5), for emitting an alert signal, if said current real height (RA) becomes less than or equal to said current threshold value.

17. The device as claimed in claim 16, wherein said second means (4) comprise at least one radioaltimeter.

18. The device as claimed in claim 16, wherein it comprises, moreover, fifth means (10) for controlling the aircraft (A) so as to increase its altitude and bring it to a security altitude, when said current real height (RA) becomes less than or equal to said current threshold value.

19. An aircraft, wherein it comprises a device (1) such as that specified under claim 16.

20. An aircraft, wherein it comprises a device (1) capable of implementing the method specified under claim 11.
